(19) United States
(12) Patent Application Publication
(10) Pub. No.: US 2020/0143175 A1
(43) Pub. Date: May 7, 2020

(54) SCENARIO DETECTION APPARATUS AND METHOD

(71) Applicant: Fujitsu Limited, Kawasaki-shi (JP)

(72) Inventors: Zhiming TAN, Beijing (CN); Xiantan ZHU, Beijing (CN); Akihiro HIGASHI, Kawasaki-shi (JP)

(73) Assignee: FUJITSU LIMITED, Kawasaki-shi (JP)

(21) Appl. No.: 16/671,760

(22) Filed: Nov. 1, 2019

(30) Foreign Application Priority Data
Nov. 6, 2018 (CN) 201811311865.4

(51) Int. Cl. G06K 9/00; G06T 7/70; G06T 7/50

(52) U.S. Cl. CPC G06K 9/00798; G06K 9/00818; G06K 9/00369; G06T 7/70; G06K 2209/23; G06T 2207/20084; G06T 2207/30256; G06T 2207/30236; G06T 7/50

(57) ABSTRACT

Embodiments of this disclosure provide a scenario detection apparatus and method, in which a scenario corresponding to a determined rule based on an input image is detected according to a result of detection of types of objects in an input image and the determined rule. Various scenarios may be efficiently detected with relatively low cost.

### CROSS-REFERENCE TO RELATED APPLICATIONS

This application is based on and hereby claims priority under 35 USC 119 to Chinese Patent Application No. 201811311865.4, filed Nov. 6, 2018, in the China National Intellectual Property Administration, the entire contents of which are incorporated herein by reference.

### TECHNICAL FIELD

This disclosure relates to the field of information technologies, and in particular to a scenario detection apparatus and method.

### BACKGROUND

With rapid developments and applications of automotive communication business (v2x) and automatic driving technologies, a need to use in-vehicle cameras to identify traffic scenarios has become increasingly urgent. Traffic scenarios may be represented by many complex factors, such as an object, a relationship between objects, a background, an environment, time, weather, and lighting. Hence, situations of a scenario may change in many different ways, making it difficult define a universal mode for all traffic scenarios.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by inventors that only subsets of types of situations can be concerned and complex methods are needed for processing complex factors in conventional methods for recognizing traffic scenarios.

Embodiments of this disclosure provide a scenario detection apparatus and method, in which a scenario corresponding to a predetermined rule in an input image is detected according to a result of detection of predetermined types of objects in an input image and the predetermined rule. Hence, various scenarios may be efficiently detected and with relatively low cost.

According to a first aspect of the embodiments of this disclosure, there is provided a scenario detection apparatus, including: a first detecting unit configured to detect predetermined types of objects in an input image to obtain information on the detected objects; and a second detecting unit configured to detect a scenario corresponding to a predetermined rule in the input image according to the information on the detected objects and the predetermined rule; wherein the predetermined types of objects are determined according to the predetermined rule.

According to a second aspect of the embodiments of this disclosure, there is provided an electronic device, including the apparatus as described in the first aspect of this disclosure.

According to a third aspect of the embodiments of this disclosure, there is provided a scenario detection method, including: detecting predetermined types of objects in an input image to obtain information on the detected objects; and detecting a scenario corresponding to a predetermined rule in the input image according to the information on the detected objects and the predetermined rule; wherein the predetermined types of objects are determined according to the predetermined rule.

An advantage of the embodiments of this disclosure exists in that a scenario corresponding to a predetermined rule in an input image is detected according to a result of detection of predetermined types of objects in an input image and the predetermined rule. Hence, various scenarios may be efficiently detected with relatively low cost.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of the scenario detection apparatus of Embodiment 1 of this disclosure;

FIG. 2 is a schematic diagram of the first detecting unit of Embodiment 1 of this disclosure;

FIG. 3 is a schematic diagram of detection results of vehicles and lanes in the input image of Embodiment 1 of this disclosure;

FIG. 4 is a schematic diagram of the second detecting unit of Embodiment 1 of this disclosure;

FIG. 5 is a schematic diagram of the first calculating unit of Embodiment 1 of this disclosure;

FIG. 6 is a schematic diagram of calculating a distance according to the input image of Embodiment 1 of this disclosure;

FIG. 7 is another schematic diagram of the first detecting unit of Embodiment 1 of this disclosure;

FIG. 8 is another schematic diagram of the second detecting unit of Embodiment 1 of this disclosure;

FIG. 9 is another schematic diagram of the first detecting unit of Embodiment 1 of this disclosure;

FIG. 10 is another schematic diagram of the second detecting unit of Embodiment 1 of this disclosure;

FIG. 11 is a schematic diagram of the electronic device of Embodiment 2 of this disclosure;

FIG. 12 is a block diagram of a systematic structure of the electronic device of Embodiment 2 of this disclosure; and

FIG. 13 is a schematic diagram of the scenario detection method of Embodiment 3 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

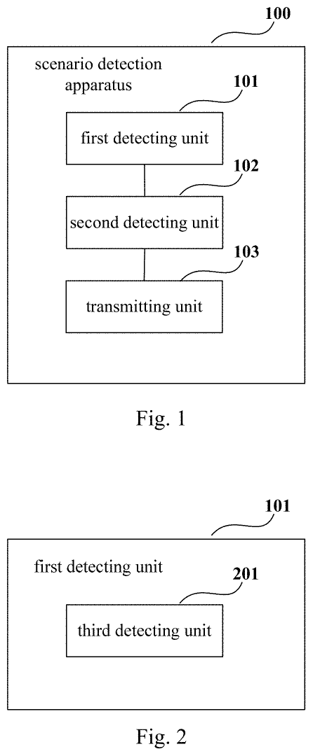

The embodiment of this disclosure provides scenario detection apparatus. FIG. 1 is a schematic diagram of the scenario detection apparatus of Embodiment 1 of this disclosure. As shown in FIG. 1, a scenario detection apparatus 100 includes a first detecting unit 101 configured to detect predetermined types of objects in an input image to obtain information on the detected objects; and a second detecting unit 102 configured to detect a scenario corresponding to a predetermined rule in the input image according to the information on the detected objects and the predetermined rule; the predetermined types of objects are determined according to the predetermined rule.

It can be seen from the above embodiment that the scenario corresponding to the predetermined rule in the input image is detected according to the result of detection of predetermined types of objects in the input image and the predetermined rule. Hence, various scenarios may be efficiently detected with relatively low cost.

In this embodiment, the input image may be obtained by a camera device in the vehicle. For example, the input image is captured by an in-vehicle camera. For example, the input image is obtained by the in-vehicle camera by capturing a front field of vision of a current vehicle.

In this embodiment, a vehicle where an in-vehicle camera used for obtaining the input image is located is referred to as the current vehicle.

In this embodiment, various detection methods may be based by the first detecting unit 101 in detecting the objects and the second detecting unit 102 in detecting the scenario. For example, the first detecting unit 101 and the second detecting unit 102 respectively detect the predetermined types of objects and the scenario in the input image based on a convolutional neural network (CNN). Reference may be made to the related art for a particular structure of the convolutional neural network.

As the convolutional neural network has a power ability to identify objects, complex factors in an actual environment may be simplified, thereby further improving the detection efficiency and the detection precision.

In this embodiment, different rules may be predetermined according to detection requirements of different scenarios, and predetermined types of objects needing to be identified, i.e., objects concerned in the rules, are determined according to the determined rules.

For example, common traffic scenarios may include traffic jam, road work, and bus waiting, etc.

In this embodiment, particular detection methods are separately described for these common scenarios; however, the embodiments of this disclosure are not limited to detection of these scenarios.

First, a detection method for a scenario of traffic jam shall be described.

FIG. 2 is a schematic diagram of the first detecting unit of Embodiment 1 of this disclosure. As shown in FIG. 2, the first detecting unit 101 includes a third detecting unit 201 configured to detect vehicles and lanes in the input image to obtain positions of the detected vehicles and lanes where the vehicles are located.

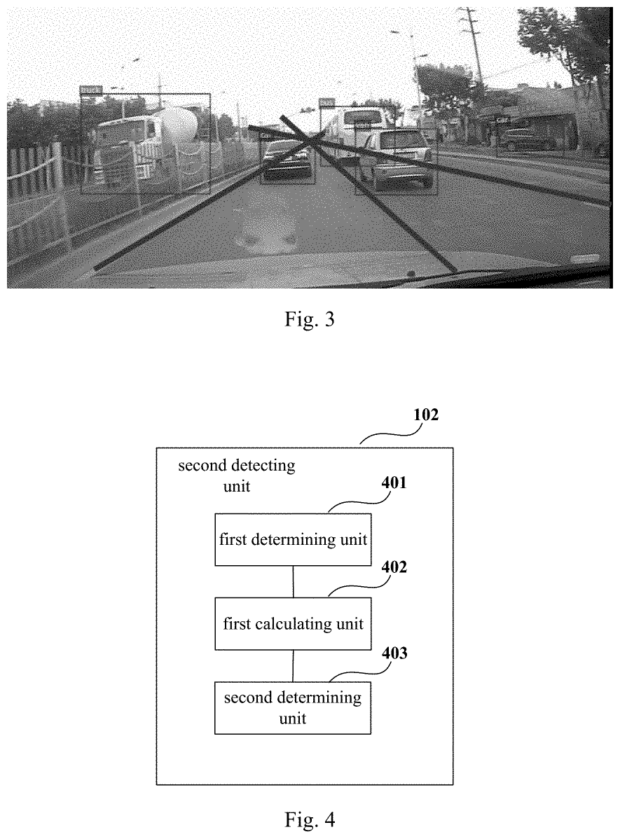

FIG. 3 is a schematic diagram of detection results of vehicles and lanes in the input image of Embodiment 1 of this disclosure. As shown in FIG. 3, the detection results include vehicles and types thereof, such as a truck, a car, a van, and a bus, and furthermore, the detection results further include information on positions of the vehicle, and lanes where the vehicles are located are determined via lane lines.

FIG. 4 is a schematic diagram of the second detecting unit of Embodiment 1 of this disclosure. As shown in FIG. 4, the second detecting unit 102 includes a first determining unit 401 configured to determine whether a lane occupancy rate is high according to the positions of the detected vehicles and the lanes where the vehicles are located; a first calculating unit 402 configured to calculate a distance between a current vehicle obtaining the input image and a vehicle in front of the current vehicle; and a second determining unit 403 configured to determine that there exists a scenario of traffic jam in the input image when it is determined that the lane occupancy rate is high and the distance is less than or equal to a first threshold.

In this embodiment, the first determining unit 401 determines whether a lane occupancy rate is high according to positions of detected vehicles and lanes where the vehicles are located. For example, it determines that the lane occupancy rate is high when the number of vehicles in a lane where a current vehicle is located is greater than or equal to a second threshold and the number of vehicles in a lane neighboring the lane where the current vehicle is located is greater than or equal to a third threshold.

In this embodiment, the second threshold and the third threshold may be set according to actual requirements. For example, the second threshold is 1, and the third threshold is 2.

For example, as shown in FIG. 3, the number of vehicles in the lane where the current vehicle capturing the input image is 1, and the number of vehicles in a lane neighboring the lane where the current vehicle is located is 2, it is determined that the lane occupancy rate is high.

In this embodiment, the first calculating unit 402 may adopt various methods to calculate the distance between the current vehicle obtaining the input image and a vehicle in front of the current vehicle. A structure of the first calculation unit 402 and its calculation method shall be illustrated below.

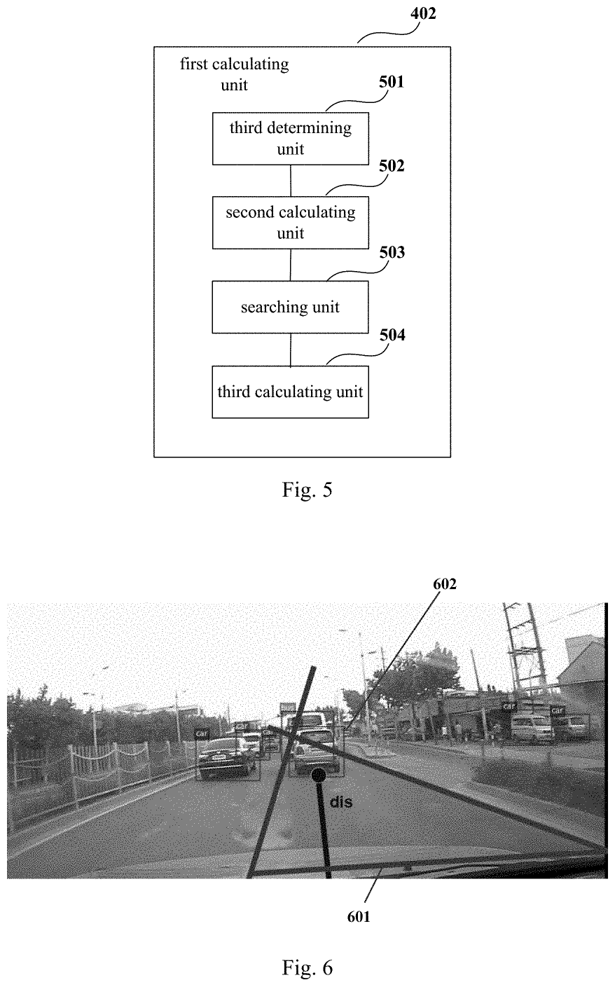

FIG. 5 is a schematic diagram of the first calculating unit of Embodiment 1 of this disclosure. As shown in FIG. 5, the first calculating unit 402 includes a third determining unit 501 configured to determine a reference triangle according to lane lines of the lane where the current vehicle is located; a second calculating unit 502 configured to calculate a focal length of an in-vehicle camera capturing the input image; a searching unit 503 configured to search a detection frame of a vehicle closest to the current vehicle in the reference triangle; and a third calculating unit 504 configured to calculate the distance between the current vehicle and the vehicle in front of the current vehicle according to the focal length and a length of a lower side of the detection frame.

FIG. 6 is a schematic diagram of calculating a distance according to the input image of Embodiment 1 of this disclosure. As shown in FIG. 6, a triangle formed by the lane lines of the lane where the current vehicle is located and a front bounding line of the current vehicle is taken as a reference triangle 601.

In this embodiment, the second calculating unit 502 calculates the focal length of the in-vehicle camera capturing the input image. For example, the focal length of the in-vehicle camera capturing the input image may be calculated by using formula (1) as below:

f=D*w/W (1);

where, f denotes the focal length of the in-vehicle camera, D denotes an actual width to which a bottom side of the reference triangle corresponds, w denotes the number of pixels in a width direction of the lane lines, and W denotes an actual width of a lane.

In this embodiment, the searching unit 503 searches a detection frame of a vehicle closest to the current vehicle in the reference triangle. For example, as shown in FIG. 6, the detection frame of the vehicle closest to the current vehicle is 602.

In this embodiment, the third calculating unit 504 calculates the distance between the current vehicle and the vehicle in front of the current vehicle according to the focal length and the length of the lower side of the detection frame. For example, the distance may be calculated by using formula (2) as below:

dis=f*W/w1 (2);

where, dis denotes the distance, f denotes the focal length of the in-vehicle camera, W denotes an actual width of a lane, and w1 denotes the number of pixels of the lower side of the detection frame.

A detection method for a scenario of road work shall be illustrated below.

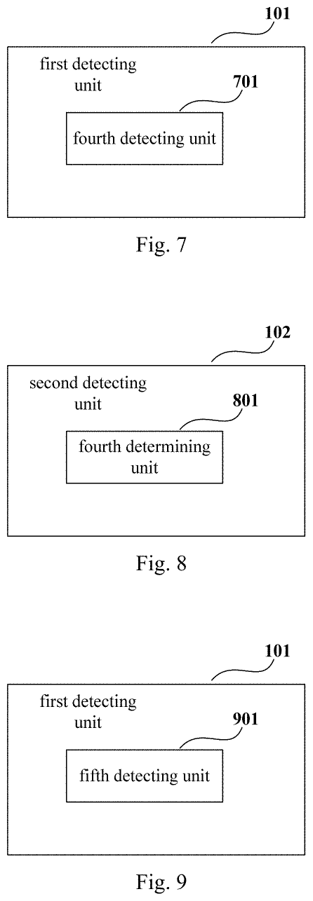

FIG. 7 is another schematic diagram of the first detecting unit of Embodiment 1 of this disclosure. As shown in FIG. 7, the first detecting unit 101 includes a fourth detecting unit 701 configured to detect identifications in the input image related to road work and the lane where the current vehicle obtaining the input image is located to obtain positions and the number of the detected identifications and the lane lines.

FIG. 8 is another schematic diagram of the second detecting unit of Embodiment 1 of this disclosure. As shown in FIG. 8, the second detecting unit 102 includes a fourth determining unit 801 configured to determine that a scenario of road work exists in the input image when the number of types of identifications of the detected identifications satisfies a predetermined condition and at least one of the detected identifications is located within the lane lines and/or intersects the lane lines. The predetermined condition may be set according to actual requirements. For example, the predetermined condition may be that the number of traffic cones is greater than or equal to 5, the number of rails is greater than or equal to 2 and the number of turning signs is greater than or equal to 1.

A detection method for a scenario of bus waiting shall be illustrated below.

FIG. 9 is another schematic diagram of the first detecting unit of Embodiment 1 of this disclosure. As shown in FIG. 9, the first detecting unit 101 includes a fifth detecting unit 901 configured to detect people, stop boards and bus stops in the input image to obtain numbers and positions of the detected people, stop boards and bus stops.

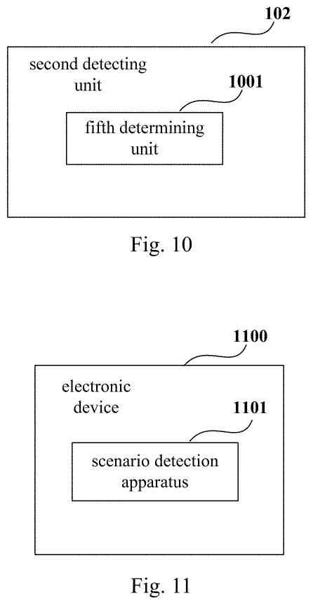

FIG. 10 is another schematic diagram of the second detecting unit of Embodiment 1 of this disclosure. As shown in FIG. 10, the second detecting unit 102 includes a fifth determining unit 1001 configured to determine that a scenario of bus waiting exists in the input image when the number of people in a predetermined range around the detected stop boards and/or bus stops is greater than or equal to a fourth threshold.

That is, when a stop sign is detected and the number of people within a predetermined range around the stop sign is greater than or equal to a fourth threshold, and/or when a bus stop is detected and people within a predetermined range around the bus stop is greater than or equal to the fourth threshold, it is determined that a scenario of bus waiting exists in the input image.

In this embodiment, the predetermined range and the fourth threshold may be set according to actual requirements. For example, the predetermined range is a range of 10 meters around the stop sign, and the fourth threshold is 1.

In this embodiment, functional units that the first detecting unit 101 and the second detecting unit 102 need to include may be determined according to actual requirements. For example, the first detecting unit 101 may include at least one of the structures shown in FIGS. 2, 7 and 9, and the second detecting units 102 may include at least one of the structures shown in FIGS. 4, 8 and 10, so as to implement a detection function of a corresponding scenario.

In this embodiment, as shown in FIG. 1, the apparatus 100 may further include:

a transmitting unit 103 configured to transmit information on the detected scenario in the input image together with information on a position of the current vehicle obtaining the input image, that is, the detected scenario and information on a position where the scenario occurs are transmitted together. For example, they may be transmitted to an intelligent traffic management system, or may be transmitted to other vehicles.

In this embodiment, the transmitting unit 103 is optional.

In this embodiment, the information on the position where the current vehicle is located may be obtained via, for example, the Global Positioning System (GPS).

Hence, by transmitting the detected scenario and the information on a position where the scenario occurs together to an intelligent traffic management system or other vehicles, a value and applicability of the detection may be improved.

It can be seen from the above embodiment that the scenario corresponding to the predetermined rule in the input image is detected according to the result of detection of predetermined types of objects in the input image and the predetermined rule. Hence, various scenarios may be efficiently detected with relatively low cost.

### Embodiment 2

The embodiment of this disclosure provides an electronic device. FIG. 11 is a schematic diagram of the electronic device of Embodiment 2 of this disclosure. As shown in FIG. 11, an electronic device 1100 includes a scenario detection apparatus 1101, a structure and functions of the scenario detection apparatus 1101 being identical to those described in Embodiment 1, which shall not be described herein any further.

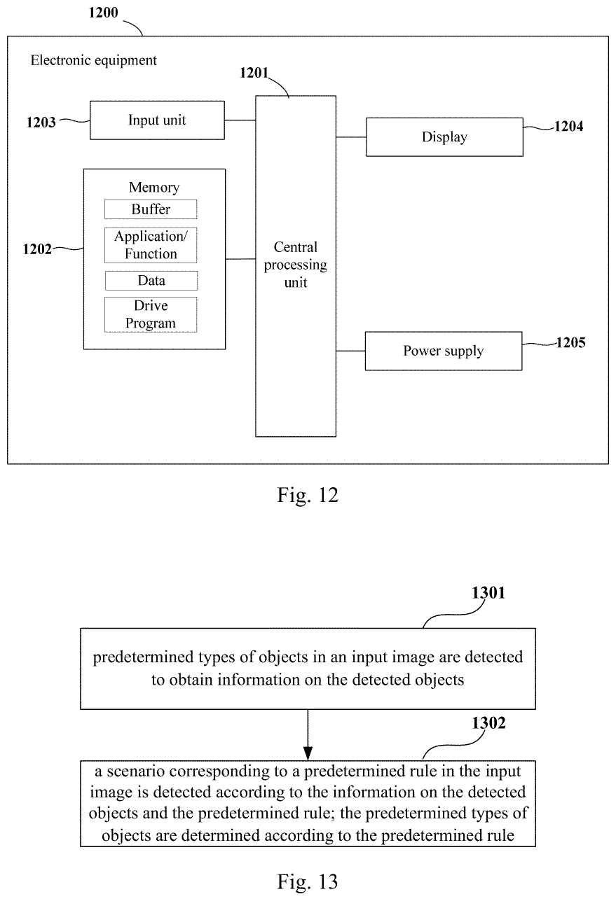

FIG. 12 is a block diagram of a systematic structure of the electronic device of Embodiment 2 of this disclosure. As shown in FIG. 12, the electronic device 1200 may include a central processing unit 1201 and a memory 1202, the memory 1202 being coupled to the central processing unit 1201. This figure is illustrative only, and other types of structures may also be used, so as to supplement or replace this structure and achieve a telecommunications function or other functions.

As shown in FIG. 12, the electronic device 1200 may further include an input unit 1203, a display 1204 and a power supply 1205.

In one implementation, the functions of the scenario detection apparatus described in Embodiment 1 may be integrated into the central processing unit 1201. The central processing unit 1201 may be configured to: detect predetermined types of objects in an input image to obtain information on the detected objects, and detect a scenario corresponding to a predetermined rule in the input image according to the information on the detected objects and the predetermined rule; the predetermined types of objects are determined according to the predetermined rule.

For example, the predetermined types of objects in the input image and the scenario in the input image are respectively detected based on the convolutional neural network.

For example, the detecting predetermined types of objects in an input image to obtain information on the detected objects includes detecting vehicles and lanes in the input image to obtain positions of the detected vehicles and lanes where the vehicles are located. And the detecting a scenario corresponding to a predetermined rule in the input image according to the information on the detected objects and the predetermined rule includes determining whether a lane occupancy rate is high according to the positions of the detected vehicles and the lanes where the vehicles are located, calculating a distance between a current vehicle obtaining the input image and a vehicle in front of the current vehicle, and determining that there exists a scenario of traffic jam in the input image when it is determined that the lane occupancy rate is high and the distance is less than or equal to a first threshold.

For example, the determining whether a lane occupancy rate is high according to the positions of the detected vehicles and the lanes where the vehicles are located includes determining that the lane occupancy rate is high when the number of vehicles in the lane where the current vehicle is located is greater than or equal to a second threshold and the number of vehicles in a lane neighboring the lane where the current vehicle is located is greater than or equal to a third threshold.

For example, the calculating a distance between a current vehicle obtaining the input image and a vehicle in front of the current vehicle includes determining a reference triangle according to lane lines of the lane where the current vehicle is located; calculating a focal length of an in-vehicle camera capturing the input image; searching a detection frame of a vehicle closest to the current vehicle in the reference triangle; and calculating the distance between the current vehicle and the vehicle in front of the current vehicle according to the focal length and a length of a lower side of the detection frame.

For example, the detecting predetermined types of objects in an input image to obtain information on the detected objects includes detecting identifications in the input image related to road work and the lane where the current vehicle obtaining the input image is located to obtain positions and the number of the detected identifications and the lane lines. And the detecting a scenario corresponding to a predetermined rule in the input image according to the information on the detected objects and the predetermined rule includes determining that a scenario of road work exists in the input image when the number of types of identifications of the detected identifications satisfies a predetermined condition and at least one of the detected identifications is located within the lane lines and/or intersects the lane lines.

For example, the detecting predetermined types of objects in an input image to obtain information on the detected objects includes detecting people, stop boards and bus stops in the input image to obtain numbers and positions of the detected people, stop boards and bus stops. And the detecting a scenario corresponding to a predetermined rule in the input image according to the information on the detected objects and the predetermined rule includes determining that a scenario of bus waiting exists in the input image when the number of people in a predetermined range around the detected stop boards and/or bus stops is greater than or equal to a fourth threshold.

For example, the input image is obtained by the in-vehicle camera of the current vehicle.

For example, the central processing unit 1201 may further be configured to: transmit information on the detected scenario in the input image together with information on a position of the current vehicle obtaining the input image.

In another implementation, the scenario detection apparatus described in Embodiment 1 and the central processing unit 1201 may be configured separately. For example, the scenario detection apparatus may be configured as a chip connected to the central processing unit 1201, with its functions being realized under control of the central processing unit 1201.

In this embodiment, the electronic device 1200 does not necessarily include all the parts shown in FIG. 12.

As shown in FIG. 12, the central processing unit 1201 is sometimes referred to as a controller or control, which may include a microprocessor or other processor devices and/or logic devices, and the central processing unit 1201 receives input and controls operations of every component of the electronic device 1200.

The memory 1202 may be, for example, one or more of a buffer memory, a flash memory, a hard drive, a mobile medium, a volatile memory, a nonvolatile memory, or other suitable devices, which may store the information on configuration, etc., and furthermore, store programs executing related information. And the central processing unit 1201 may execute programs stored in the memory 1202, so as to realize information storage or processing, etc. Functions of other parts are similar to those of the related art, which shall not be described herein any further. The parts of the electronic device 1200 may be realized by specific hardware, firmware, software, or any combination thereof, without departing from the scope of this disclosure.

It can be seen from the above embodiment that the scenario corresponding to the predetermined rule in the input image is detected according to the result of detection of predetermined types of objects in the input image and the predetermined rule. Hence, various scenarios may be efficiently detected with relatively low cost.

### Embodiment 3

The embodiment of this disclosure provides a scenario detection method, which corresponds to the scenario detection apparatus described in Embodiment 1. FIG. 13 is a schematic diagram of the scenario detection method of Embodiment 3 of this disclosure. As shown in FIG. 13, the method includes Step 1301: predetermined types of objects in an input image are detected to obtain information on the detected objects; and Step 1302: a scenario corresponding to a predetermined rule in the input image is detected according to the information on the detected objects and the predetermined rule; the predetermined types of objects are determined according to the predetermined rule.

In this embodiment, reference may be made to Embodiment 1 for particular methods for executing the above steps, which shall not be described herein any further.

It can be seen from the above embodiment that the scenario corresponding to the predetermined rule in the input image is detected according to the result of detection of predetermined types of objects in the input image and the predetermined rule. Hence, various scenarios may be efficiently detected with relatively low cost.

An embodiment of the present disclosure provides a computer readable program, which, when executed in a scenario detection apparatus or an electronic device, may cause a computer to carry out the scenario detection method as described in Embodiment 3 in the scenario detection apparatus or the electronic device.

An embodiment of the present disclosure provides a computer storage medium, including a computer readable program, which may cause a computer to carry out the scenario detection method as described in Embodiment 3 in a scenario detection apparatus or an electronic device.

The scenario detection method carried out in the scenario detection apparatus or the electronic device described with reference to the embodiments of this disclosure may be directly embodied as hardware, software modules executed by a processor, or a combination thereof. For example, one or more functional block diagrams and/or one or more combinations of the functional block diagrams shown in FIG. 1 may either correspond to software modules of procedures of a computer program, or correspond to hardware modules. Such software modules may respectively correspond to the steps shown in FIG. 13. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 1 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 1 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. A scenario detection method, including: detecting predetermined types of objects in an input image to obtain information on the detected objects; and detecting a scenario corresponding to a predetermined rule in the input image according to the information on the detected objects and the predetermined rule; wherein the predetermined types of objects are determined according to the predetermined rule.

Supplement 2. The method according to supplement 1, wherein, the predetermined types of objects in the input image and the scenario in the input image are respectively detected based on a convolutional neural network.

Supplement 3. The method according to supplement 1, wherein, the detecting predetermined types of objects in an input image to obtain information on the detected objects includes detecting vehicles and lanes in the input image to obtain positions of the detected vehicles and lanes where the vehicles are located; and the detecting a scenario corresponding to a predetermined rule in the input image according to the information on the detected objects and the predetermined rule includes determining whether a lane occupancy rate is high according to the positions of the detected vehicles and the lanes where the vehicles are located; calculating a distance between a current vehicle obtaining the input image and a vehicle in front of the current vehicle; and determining that there exists a scenario of traffic jam in the input image when it is determined that the lane occupancy rate is high and the distance is less than or equal to a first threshold.

Supplement 4. The method according to supplement 3, wherein, the determining whether a lane occupancy rate is high according to the positions of the detected vehicles and the lanes where the vehicles are located includes determining that the lane occupancy rate is high when the number of vehicles in the lane where the current vehicle is located is greater than or equal to a second threshold and the number of vehicles in a lane neighboring the lane where the current vehicle is located is greater than or equal to a third threshold.

Supplement 5. The method according to supplement 3, wherein, the calculating a distance between a current vehicle obtaining the input image and a vehicle in front of the current vehicle includes determining a reference triangle according to lane lines of the lane where the current vehicle is located; calculating a focal length of an in-vehicle camera capturing the input image; searching a detection frame of a vehicle closest to the current vehicle in the reference triangle; and calculating the distance between the current vehicle and the vehicle in front of the current vehicle according to the focal length and a length of a lower side of the detection frame.

Supplement 6. The method according to supplement 1, wherein, the detecting predetermined types of objects in an input image to obtain information on the detected objects includes detecting identifications in the input image related to road work and the lane where the current vehicle obtaining the input image is located to obtain positions and the number of the detected identifications and the lane lines; and the detecting a scenario corresponding to a predetermined rule in the input image according to the information on the detected objects and the predetermined rule includes determining that a scenario of road work exists in the input image when the number of types of identifications of the detected identifications satisfies a predetermined condition and at least one of the detected identifications is located within the lane lines and/or intersects the lane lines.

Supplement 7. The method according to supplement 1, wherein, the detecting predetermined types of objects in an input image to obtain information on the detected objects includes detecting people, stop boards and bus stops in the input image to obtain numbers and positions of the detected people, stop boards and bus stops; and the detecting a scenario corresponding to a predetermined rule in the input image according to the information on the detected objects and the predetermined rule includes determining that a scenario of bus waiting exists in the input image when the number of people in a predetermined range around the detected stop boards and/or bus stops is greater than or equal to a fourth threshold.

Supplement 8. The method according to supplement 1, wherein, the input image is obtained by the in-vehicle camera of the current vehicle. Supplement 9. The method according to supplement 1, wherein the method further includes transmitting information on the detected scenario in the input image together with information on a position of the current vehicle obtaining the input image.

1. A scenario detection apparatus, comprising:
a memory; and
a processor coupled to the memory and to,
detect types of objects in an input image to obtain information on the detected objects; and
detect existence of a scenario corresponding to a determined rule based on the input image according to the information on the detected objects and the determined rule;
wherein the types of objects are determined according to the determined rule.

2. The apparatus according to claim 1, wherein the processor is to respectively detect the types of objects and the scenario in the input image, based on a convolutional neural network.

3. The apparatus according to claim 1, wherein the processor is to,
detect, in the input image, vehicles and lanes where the vehicles are located to obtain positions of the detected vehicles and the lanes where the vehicles are located;
determine whether a lane occupancy rate is high according to the positions of the detected vehicles and the lanes where the vehicles are located;
calculate a distance between a current vehicle obtaining the input image and a vehicle in front of the current vehicle; and
determine a scenario of traffic jam exists based on the input image when determined that the lane occupancy rate is high and the distance is less than or equal to a first threshold.

4. The apparatus according to claim 3, wherein,
the processor is to determine that the lane occupancy rate is high when a number of the vehicles in a lane, among the lanes, where the current vehicle is located is greater than or equal to a second threshold and a number of the vehicles in a lane neighboring the lane where the current vehicle is located is greater than or equal to a third threshold.

5. The apparatus according to claim 3, wherein the processor is to,
determine a reference triangle according to lane lines of a lane, among the lanes, where the current vehicle is located;
calculate a focal length of an in-vehicle camera capturing the input image;
search a detection frame of a vehicle closest to the current vehicle in the reference triangle; and
calculate the distance between the current vehicle and the vehicle in front of the current vehicle according to the focal length and a length of a lower side of the detection frame.

6. The apparatus according to claim 1, wherein the processor is to,
detect identifications in the input image related to road work and a lane, among the lanes, where a current vehicle obtaining the input image is located to obtain positions and a number of the detected identifications and lane lines of the lanes; and
determine that a scenario of road work exists based on the input image when a number of types of identifications of the detected identifications satisfies a condition and at least one of the detected identifications is located within the lane lines and/or intersects the lane lines.

7. The apparatus according to claim 1, wherein the processor is to,
detect people, stop boards and bus stops in the input image to obtain numbers and positions of the detected people, stop boards and bus stops; and
determine that a scenario of bus waiting exists based on the input image when a number of people in a determined range around the detected stop boards and/or bus stops is greater than or equal to a fourth threshold.

8. The apparatus according to claim 1, wherein the input image is obtained by an in-vehicle camera of a vehicle.

9. The apparatus according to claim 8, further comprising:
a transmitter to transmit information on the detected scenario in the input image together with information on a position of the vehicle obtaining the input image.

10. An electronic device, comprising the apparatus as claimed in claim 1.
